(19) United States
(12) Patent Application Publication
(10) Pub. No.: US 2019/0099763 A1
(43) Pub. Date: Apr. 4, 2019

(54) CENTRIFUGE ROTOR WITH STAGGERED NOZZLES FOR USE IN A DISC NOZZLE CENTRIFUGE

(71) Applicant: Fluid-Quip, Inc., Springfield, OH (US)

(72) Inventor: Andrew Franko, Bellbrook, OH (US)

(21) Appl. No.: 16/087,291

(22) PCT Filed: Mar. 23, 2017
(86) PCT No.: PCT/US2017/023785

§ 371 Date: Sep. 21, 2018

Related U.S. Application Data
(60) Provisional application No. 62/312,782, filed on Mar. 24, 2016.

(51) Int. Cl. B04B 1/12; F04D 29/28

(52) U.S. Cl. CPC B04B 1/12; F01D 5/048; F04D 29/287

(57) ABSTRACT

This invention is directed to a centrifuge rotor, such as for use in a disc nozzle centrifuge, having a bowl including an improved positioning and orientation of discharge nozzles for facilitating tangential flow of fluid discharged therefrom relative to the rotor bowl.

### CROSS REFERENCE TO RELATED APPLICATION

This application claims the benefit of U.S. Provisional Patent Application Ser. No. 62/312,782, filed Mar. 24, 2016 and hereby incorporated by reference in its entirety.

### TECHNICAL FIELD

This invention generally relates to centrifuge rotors, such as for use in a disc nozzle centrifuge, and, more particularly, to a rotor bowl including an improved positioning and orientation of discharge nozzles for facilitating tangential flow of fluid discharged therefrom relative to the rotor bowl.

### BACKGROUND

Disc nozzle centrifuges have been used for many years to separate liquids and/or solids of different mass densities. The separation is accomplished by subjecting a slurry feed stream (with particles or liquids to be separated) to very high centrifugal force(s). The forces are created by sending the slurry into a bowl and spinning the bowl at a very high rotational velocity, such as, for example, 2,900 rotations per minute for a bowl having an inner diameter of 37 inches at its largest cross section and an outer diameter of 42.25 inches at its largest cross section (sometimes referred to as a “36-inch bowl”). Discharge nozzles are installed on the periphery of the bowl to limit or restrict the discharge of the slurry feed stream causing a heavy or underflow fraction to migrate to the outside of the bowl while a light or overflow fraction is forced to the inside. The heavy discharge slurry or underflow fraction is delivered outside the rotor by the discharge nozzles, which are supported within an outer wall of the bowl, and the light fraction or overflow fraction (separated liquid) is removed from the bowl as overflow from the top end of the machine.

Typically, the rotor bowl has a bulging shape with discharge nozzles inserted through the wall of the bowl at its largest diameter. These nozzles may be accommodated by a small cylindrical section of the bowl at this largest diameter. However, it is desirable to keep the width of this cylindrical section to a minimum in order to optimize the flow path inside of the bowl chamber, as well as for gyroscopic and/or moment of inertia concerns. The nozzles allow a percentage of the slurry to travel from inside of the bowl (e.g. the bowl chamber) to outside of the bowl, and there must be sufficient nozzles positioned through the wall of the bowl to avoid plugging inside of the bowl. Thus, in a typical bowl having a maximum outer diameter of 42.25 inches, there may be approximately 30 nozzles positioned through the wall in a continuous ring along the cylindrical section.

One arrangement illustrating centrifuge nozzles secured within a rotor wall is disclosed in U.S. Pat. No. 2,695,748 to Millard. In this arrangement, a plurality of nozzles are mounted at regularly spaced intervals about the periphery of the rotor wall. More particularly, the rotor wall is provided with a plurality of cylindrical bores for receiving the nozzles wherein the axis of each bore is radially disposed with respect to the axis of the rotor. A lug is formed integral with the body of the nozzle for detachably securing each nozzle within the rotor wall.

In conventional disc nozzle centrifuges, the energy required to spin a rotor bowl is generally supplied by an electric motor. In order to recover a portion of the energy consumed by the motor, discharge nozzles are occasionally designed to direct the flow from the nozzle somewhat tangentially to the diameter of the bowl to assist in spinning the bowl. For example, the flow from a bowl rotating clockwise may be discharged in the opposite direction. Due to the high forces generated, the pressure inside the bowl can be very high, such as approximately 1,000 psig in a disc nozzle centrifuge bowl having an inner diameter of 37 inches and an outer diameter of 42.25 inches at its largest cross section. Redirecting the flow from the nozzle requires a sharp turn for the discharged material within the nozzle to change from an outward radial direction to the somewhat tangential flow. However, conventional nozzles are typically inset within the wall of the bowl and do not protrude past the outside diameter of the bowl, such that the flow cannot be completely tangential, which would provide the maximum energy recovery possible. Moreover, a significant angle off tangential such as, for example, approximately 10 to 15 degrees, has been typically required to avoid the dispersing stream discharging out of the nozzle and impacting and wearing the bowl appreciably. In addition, scallops in the bowl adjacent the nozzles are usually needed to provide clearance for the nozzle discharge.

Some attempts have been made to use nozzles that project beyond the outside diameter of the bowl to allow a more tangential discharge, but these have all resulted in a problem of creating wear on the backsides of trailing nozzles caused by the streams flowing out of leading nozzles. In other words, the flow stream discharged from each nozzle impacts on an adjacent nozzle, resulting in undesirable nozzle erosion. This may be especially problematic in cases where the nozzles allow the liquid stream to disperse or diffract in a conically spreading flow stream. In such cases at least some angle off tangential such as, for example, approximately 10 degrees, may be required to ensure that neither the backside of the nozzles nor the bowl appreciably wear. Due to the large number of nozzles required to prevent plugging within the bowl, this problem may not be alleviated by simply reducing the number of nozzle holes and spacing the nozzles sufficiently far apart so as to not cause wear on each other.

It would therefore be desirable to provide a centrifuge rotor, such as for use in a disc nozzle centrifuge, having an improved positioning and orientation of nozzles for facilitating tangential flow therefrom while minimizing wear problems.

### SUMMARY

In one embodiment, a centrifuge rotor is provided that includes a bowl including a bowl chamber for receiving a slurry to be separated and a first plurality of nozzle holes positioned on a first plane along a middle portion of the bowl and a second plurality of nozzle holes positioned on a second plane along the middle portion of the bowl. The middle portion includes a largest outside diameter of the bowl. The first plane defines a centerline for the first plurality of nozzle holes and the second plane defines a centerline for the second plurality of nozzle holes. Each nozzle hole is configured to receive a discharge nozzle so that each of the discharge nozzles protrude beyond the largest outside diameter of the bowl to direct fluid flow from the bowl chamber substantially tangentially to the largest outside diameter of the bowl. The centrifuge rotor can be used in a disc nozzle centrifuge.

In another embodiment, a centrifuge rotor is provided that includes a bowl including a bowl chamber for receiving a slurry to be separated and a first plurality of nozzle holes positioned on a first plane along a middle portion of the bowl and a second plurality of nozzle holes positioned on a second plane along the middle portion of the bowl. The middle portion includes a largest outside diameter of the bowl. The first plane defines a centerline for the first plurality of nozzle holes and the second plane defines a centerline for the second plurality of nozzle holes. The first plurality of nozzle holes is offset relative to the second plurality of nozzle holes. Each of the first plurality of nozzle holes and each of the second plurality of nozzle holes are equally spaced apart at regular intervals, and the largest outside diameter of the bowl is a constant diameter. The centrifuge rotor further includes a plurality of discharge nozzles. Each of the plurality of discharge nozzles is positioned within a corresponding nozzle hole of the first and second pluralities of nozzle holes and protrudes beyond the largest outside diameter of the bowl to direct fluid flow from the bowl chamber substantially tangentially to the largest outside diameter of the bowl.

In yet another embodiment, a method for centrifuging a slurry is provided that includes supplying a slurry including fluid to a bowl of a centrifuge rotor having a first plurality of discharge nozzles centered on a first plane along a middle portion of the bowl and a second plurality of discharge nozzles centered on a second plane along the middle portion of the bowl, the middle portion including a largest outside diameter of the bowl. The method also includes centrifugally forcing, via rotation of the bowl, at least a portion of the fluid into the first and second pluralities of discharge nozzles. The method further includes directing the centrifugally forced fluid out of the first and second pluralities of discharge nozzles in a direction substantially tangential to the largest outside diameter of the bowl.

### BRIEF DESCRIPTION OF THE DRAWINGS

FIG. 1 is a partial perspective cutaway view of a disc nozzle centrifuge rotor, with a portion of the centrifuge rotor shown in phantom, in accordance with an embodiment of the invention.

FIG. 2 is a partial top view of the rotor bowl and hub shown in FIG. 1.

FIG. 3 is a cross-sectional view of the rotor bowl and hub of FIG. 2, taken along line 3-3.

FIG. 4 is a cross-sectional view of the rotor bowl of FIG. 3, taken along line 4-4.

FIG. 5 is a cross-sectional view similar to FIG. 4, showing the extended bowl insert exploded from the nozzle hole.

FIG. 6 is a cross-sectional view similar to FIG. 4, showing a nozzle positioned within the extended bowl insert.

FIG. 7 is a cross-sectional view similar to FIG. 6, showing another embodiment of the nozzle and the extended bowl insert.

### DETAILED DESCRIPTION

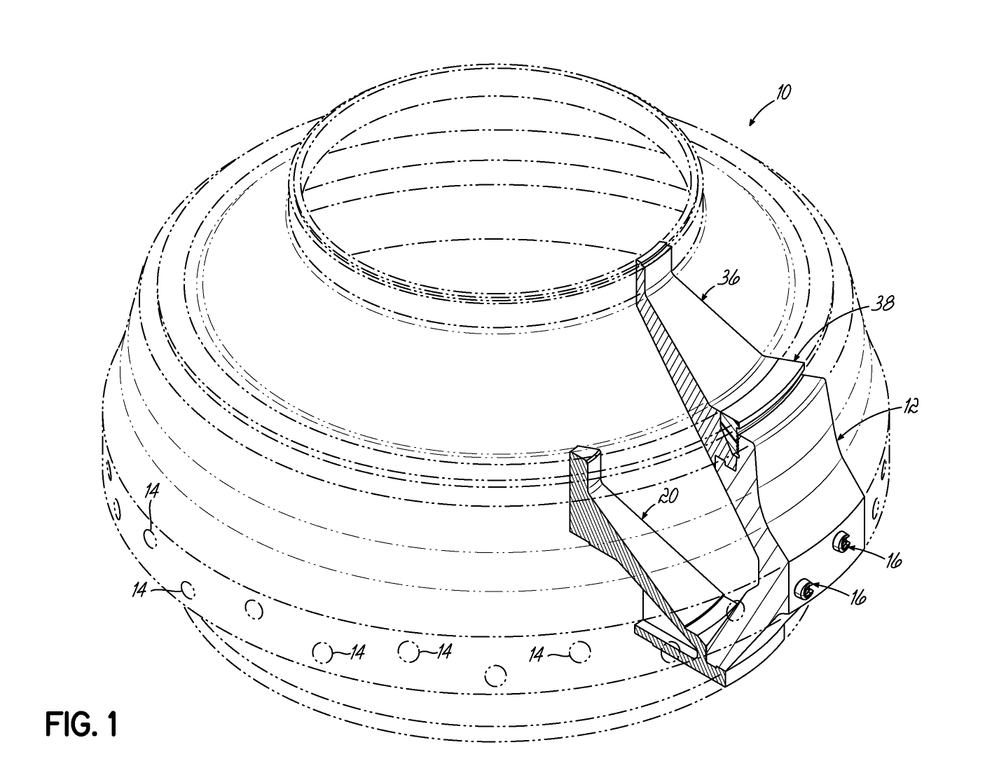

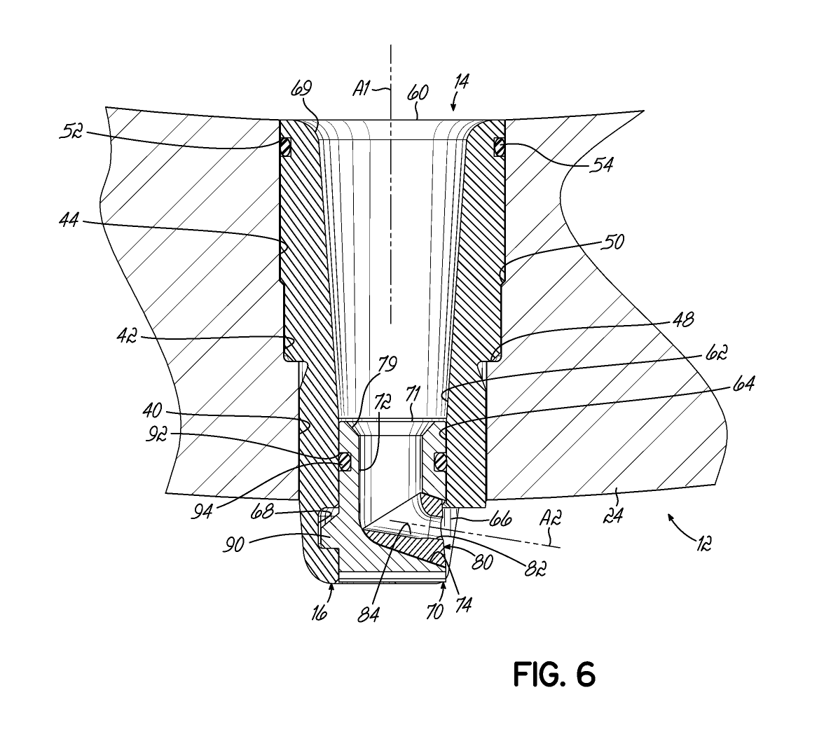

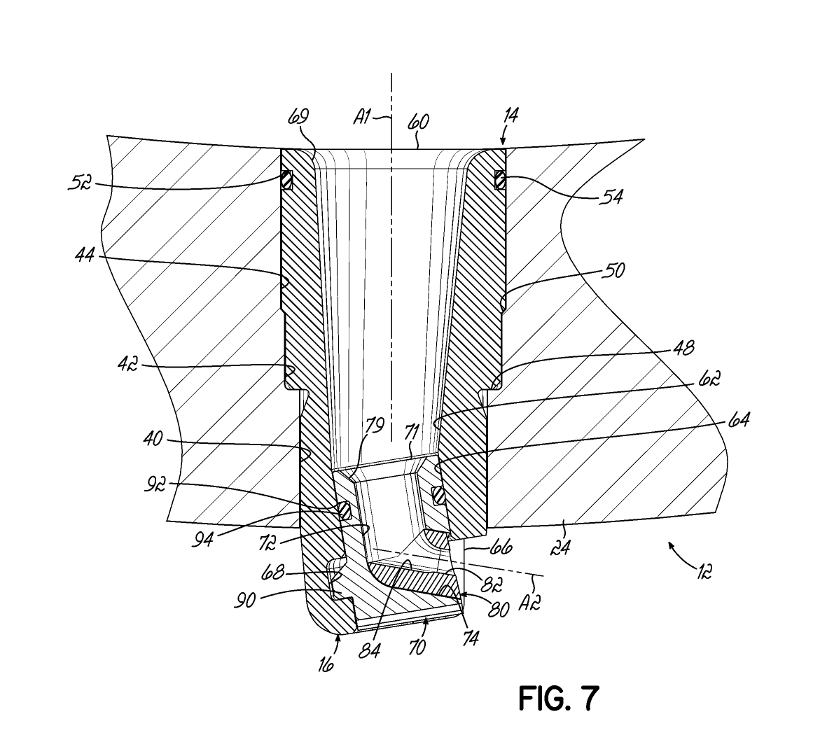

With reference to FIGS. 1-3, a disc nozzle centrifuge rotor 10 in accordance with an embodiment of the invention is shown. As set forth in further detail below, the centrifuge rotor 10 includes a bowl 12 having a plurality of nozzle holes 14 positioned on first and second planes P1, P2 in a staggered manner. A plurality of extended bowl inserts 16 for holding discharge nozzles 70 (FIGS. 6 and 7) are placed in the nozzle holes 14. As such, rather than positioning the entire supply of nozzles 70 along a single continuous ring, a portion of the nozzles 70 may be positioned on the first plane P1 while the remaining nozzles 70 may be positioned on the second plane P2. Thus, a nozzle 70 positioned on the first or second plane P1, P2 may protrude beyond the outside diameter of the bowl 12 to direct the flow from the nozzle 70 tangentially to the outside diameter of the bowl 12, and may also be positioned sufficiently far from an adjacent nozzle 70 on the same plane P1, P2 such that flow discharged therefrom may not impact upon a backside of the adjacent nozzle 70 (or associated bowl insert 16). In addition, as discussed in greater detail below, the nozzles 70 may each discharge a substantially cylindrical flow stream, such that the flow discharged from each nozzle 70 may neither impact upon the bowl 12 nor an adjacent nozzle 70 (or associated bowl insert 16) on the other of the first or second plane P1, P2. As a result, when the bowl 12 is rotated such as, for example, in the clockwise direction, the nozzles 70 may provide the maximum energy recovery possible by assisting in the spinning of the bowl 12 via the tangential discharge of flow in the opposite direction, while avoiding undesirable wear on the backsides of the nozzles 70, the bowl inserts 16, and/or the bowl 12. Thus, a significant amount of energy may be saved without damaging the various components of the centrifuge rotor 10. The features of the centrifuge rotor 10 are set forth in further detail below to clarify each of these functional advantages and other benefits provided in this disclosure.

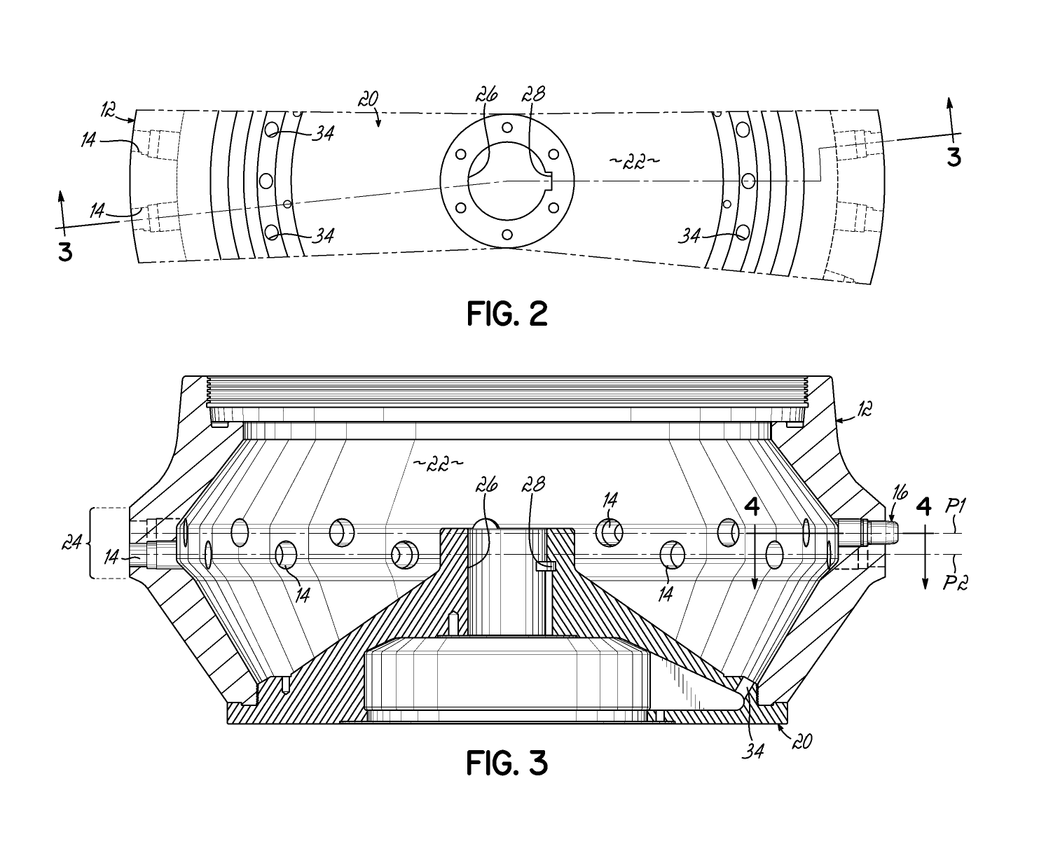

As best shown in FIG. 1, the centrifuge rotor 10 includes a bowl 12 positioned over a hub 20. In one embodiment, the bowl 12 and hub 20 may each include corresponding male and female threading such that the hub 20 may be threaded into the bowl 12, and a seal (not shown) may be provided between the bowl 12 and the hub 20 to prevent leakage. As shown, the bowl 12 includes a bowl chamber 22, which may be at least partially defined by the hub 20, for receiving a slurry to be separated. The bowl 12 has a bulging shape such that its outer diameter increases toward a middle portion of the bowl, where a small cylindrical section 24 (e.g. a section having constant diameter) is provided at the bowl's largest diameter. As is generally known, the hub 20 may include a shaft bore 26 and a key way 28 for selectively receiving a rotatable shaft (not shown) operable to rotate the centrifuge rotor 10, as well as return holes 34 (FIG. 2), and the centrifuge rotor 10 may further include a bowl cover 36 and a lock ring 38 for securing the bowl cover over the bowl 12.

In the embodiment shown, a plurality of nozzle holes 14 are provided in the cylindrical section 24 of the bowl 12 on first and second parallel planes P1, P2, as best shown in FIG. 3. More specifically, the first plane P1 defines the centerlines for a first set of nozzle holes 14 and the second plane P2 defines the centerlines for a second set of nozzle holes 14. As shown, an equal number of nozzle holes 14 may be provided in each set, and the nozzle holes 14 of each set may be equally spaced apart at regular intervals. Also, the nozzle holes 14 in one set may be staggered, or offset, from an adjacent hole(s) 14 in the other set such that a hole 14 on the second plane P2 is not directly below a hole 14 on the first plane P1. For example, the holes 14 may be spaced apart such that each hole 14 on the second plane P2 is located approximately halfway between the nearest holes 14 on the first plane P1. In one embodiment wherein the dimensions of the bowl 12 are approximately equal to those of a 36-inch bowl, the first and second sets may each include approximately 15 equally-spaced nozzle holes 14, such that a total of approximately 30 nozzle holes 14 may be provided through the cylindrical section 24.

In one example, it may be desirable to provide an even number of nozzle holes 14 along each plane P1, P2, in order to avoid imbalances in the bowl 12 which might cause an undesirable gyroscopic effect. By providing an even number of nozzle holes 14 along each plane P1, P2, each nozzle hole 14 may be positioned opposite a corresponding nozzle hole 14 on the same plane P1, P2 and thus ensure proper balance of the bowl 12 during operation. For example, in the aforementioned embodiment wherein the dimensions of the bowl 12 are approximately equal to those of a 36-inch bowl, the first and second sets may each include 14 nozzle holes or may each include 16 nozzle holes, such that a total of 28 nozzle holes or 32 nozzle holes may be provided. However, it will be appreciated that any number of nozzle holes 14 may be provided on each plane P1, P2.

Similarly, in one example, the first and second planes P1, P2 may be equally spaced from a centerline of the cylindrical section 24 for balance purposes, and may be closer together or farther apart than illustrated in FIG. 3. In one embodiment, a third plane may be provided along the centerline of the cylindrical section 24 and may define the centerlines for a third set of nozzle holes 14 (not shown). Any number of additional planes may define the centerlines for additional sets of nozzle holes 14 in the cylindrical section 24 of the bowl 12. However, it may be desirable to provide such additional planes in pairs, with one spaced above the centerline of the cylindrical section 24 and the other spaced below the centerline of the cylindrical section 24 at the same distance, to ensure proper balance of the bowl 12 during operation. In addition, as previously mentioned, it may be desirable to keep the width of the cylindrical section 24 at a minimum, and thus in certain embodiments the number of planes and the distance therebetween may be minimized.

While the first and second planes P1, P2 are described herein as defining the centerlines for the nozzle holes 14, in some embodiments at least some of the nozzle holes 14 may be offset, or positioned off center relative to the respective plane P1, P2. In such cases, it may be desirable to offset a particular nozzle hole 14 at the same distance as an opposing nozzle hole 14 on the same plane P1, P2, for balance purposes.

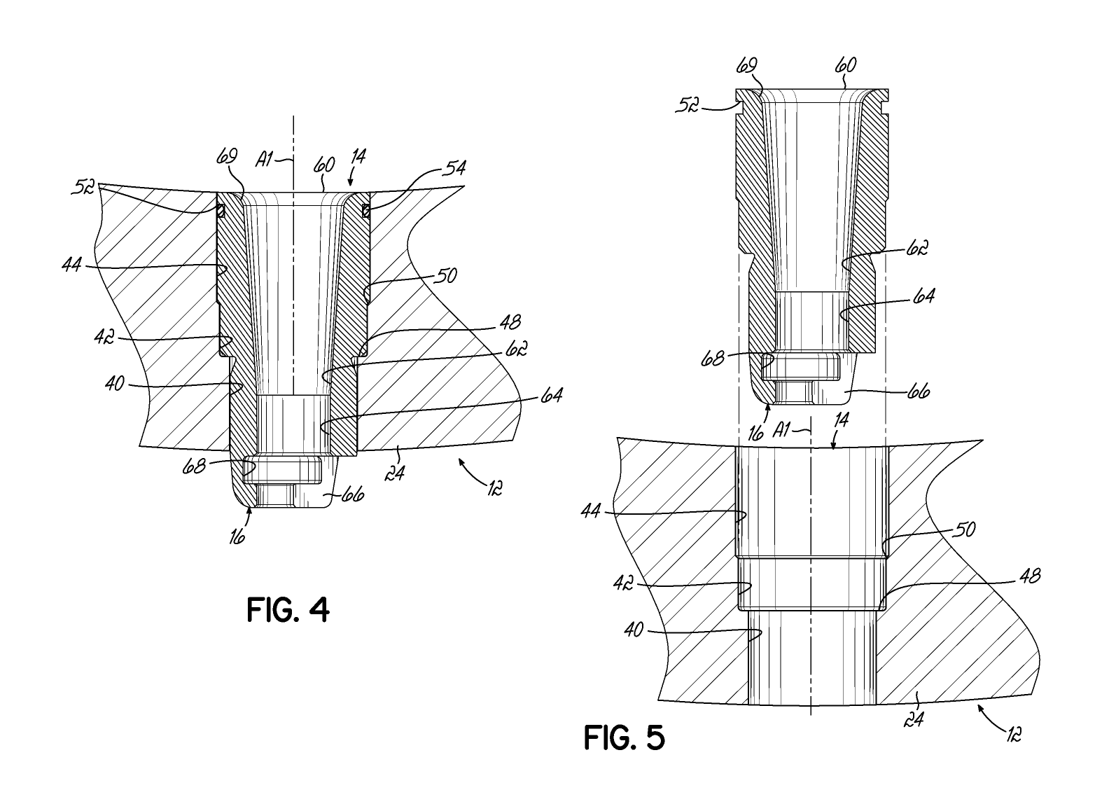

Referring now to FIGS. 4 and 5, each nozzle hole 14 may include first, second, and third bores 40, 42, 44 defining a bore axis A1. An extended bowl insert 16 is positioned within each of the nozzle holes 14. To that end, each extended bowl insert 16 has first, second, and third outer diameters corresponding to the diameters of the first, second, and third bores 40, 42, 44, respectively, in order to provide an interference fit therebetween. In addition, the first and second bores 40, 42 form a first shoulder 48 and the second and third bores 42, 44 form a second shoulder 50. The first and second shoulders 48, 50 supply positive stops to the bowl insert 16, thereby preventing the bowl insert 16 from becoming dislodged during use. In addition or alternatively, the extended bowl insert 16 may be retained by tapering one or more of the nozzle hole bores 40, 42, 44 and providing corresponding taper(s) on the outer surface of the bowl insert 16. Other configurations are contemplated here and would be appreciated by one having ordinary skill in the art. At least one annular slot 52 is provided along at least one of the outer diameters of the bowl insert 16 for receiving an O-ring 54 therein so as to provide a fluid tight seal between the extended bowl insert 16 and the bowl 12.

Each extended bowl insert 16 includes an inlet 60, a fluid passageway 62, a cavity 64 for receiving a nozzle 70, and an outlet 66 for providing clearance to a fluid discharge stream exiting the nozzle 70. The cavity 64 may include a locking groove 68 for receiving a locking mechanism, such as a lug 90 (FIGS. 6 and 7), of a nozzle 70 to secure the nozzle 70 within the cavity 64. As shown, the fluid passageway 62 may have a generally conical shape. For example, the fluid passageway 62 may have a relatively large diameter at the inlet 60 (e.g. slightly less than the diameter of the third bore 44), and may taper toward the cavity 64. In this manner, a fluid stream exiting the bowl chamber 22 through the nozzle hole 14 may be converged within the fluid passageway 62 prior to entering a nozzle 70 positioned within the cavity 64. As shown, a radius 69 may be provided at the inlet 60 to provide a smooth transition for fluid flow into the extended bowl insert 16 from the bowl chamber 22.

With reference now to FIG. 6, a discharge nozzle 70 is positioned within each of the extended bowl inserts 16 and, more specifically, within the cavity 64 of each of the bowl inserts 16. In one embodiment, the nozzles 70 may be designed to have as smooth a transition through the nozzle 70 as possible so that frictional losses of a fluid stream passing therethrough are minimized. For example, the nozzles 70 may be of a design similar to that disclosed in commonly owned U.S. Pat. No. 6,511,005, the contents of which are herein incorporated by reference in its entirety. To that end, each nozzle 70 may include a nozzle inlet 71, an inlet channel 72, and an outlet channel 74 disposed angularly with respect to the inlet channel 72 for receiving an insert 80 therein. The insert 80 includes an orifice portion 82 and a directing portion 84 which may shield at least a portion of the outlet channel 74 for preventing impact of a fluid stream therewith and for diverting fluid flow from the inlet channel 72 into the orifice portion 82 along an outlet axis A2. The size of the orifice portion 82 may vary depending on the application.

The nozzle 70 may further include a locking mechanism, such as a lug 90, extending radially outwardly therefrom and which may be positioned within the locking groove 68 of the extended bowl insert 16 such that the nozzle 70 may be detachably secured within the bowl insert 16. An annular groove 92 may be provided along an outer diameter of the nozzle 70 for receiving an O-ring 94 therein, so as to provide a fluid tight seal between the nozzle 70 and the extended bowl insert 16.

As shown, the insert 80 of the nozzle 70 may be configured such that, when the axis of the nozzle inlet channel 72 is in straight alignment with the bore axis A1, the outlet axis A2 of the nozzle 70 is disposed angularly with respect to the bore axis A1 at a substantially perpendicular angle, so that a fluid stream exiting the nozzle 70 may be substantially tangential to the outer diameter of the bowl 12. For example, the outlet axis A2 of the nozzle 70 may be disposed angularly with respect to the bore axis A1 at an angle of between approximately 80 degrees and approximately 110 degrees. While the preferred angle may be 90 degrees for achieving maximum energy recovery, in some embodiments a wider angle such as 100 degrees or 110 degrees may be necessary to allow the discharge stream to clear the bore insert 16 and/or the bowl 12. As shown, this may be achieved by configuring the surface of the directing portion 84 upon which the fluid stream impacts so as to be substantially perpendicular to the bore axis A1. For example, a surface of the directing portion 84 may be angled between approximately 80 degrees and approximately 110 degrees relative to the axis of the nozzle inlet channel 72, which may be positioned in straight alignment with the bore axis A1 as shown. A taper 79 may be provided at the nozzle inlet 71 to provide a smooth transition for fluid flow converging into the nozzle inlet channel 72 from the fluid passageway 62.

Referring now to FIG. 7, where like numerals refer to like features, in an alternative embodiment, the nozzle 70 may be angled relative to the bore axis A1. This may be desirable in applications where the insert 80 of the nozzle 70 is not configured to orient the outlet axis A2 of the nozzle 70 substantially perpendicular to the bore axis A1. For example, unlike in the previous embodiment, the surface of the directing portion 84 upon which the fluid stream impacts may not be substantially perpendicular to the axis of the nozzle inlet channel 72. Rather, the surface of the directing portion 84 may be angled greater than approximately 110 degrees relative to the axis of the nozzle inlet channel 72. In such cases, a straight alignment of the nozzle inlet channel 72 with the bore axis A1 would not allow the fluid stream exiting the nozzle 70 to be substantially tangential to the outer diameter of the bowl 12. Thus, a correction angle may be provided by orienting the nozzle 70 within the extended bowl insert 16 such that the outlet axis A2 of the nozzle 70 is disposed angularly with respect to the bore axis A1 at a substantially perpendicular angle, so that a fluid stream exiting the nozzle 70 may be substantially tangential to the outer diameter of the bowl 12. As in the previous embodiment, the outlet axis A2 of the nozzle 70 may be disposed angularly with respect to the bore axis A1 at an angle of between approximately 80 degrees and approximately 110 degrees, with a preferred angle of approximately 90 degrees. In the embodiment shown in FIG. 7, this is achieved by angling the cavity 64 of the extended bore insert 16 with respect to the bore axis A1 at a correction angle to account for the substantially non-perpendicular angling of the outlet axis A1 relative to the axis of the nozzle inlet channel 72 and thereby achieve the desired angular disposition of the outlet axis A2 with respect to the bore axis A1. This arrangement may be particularly advantageous in applications where a pre-existing nozzle 70 whose insert 80 is not specifically configured to achieve substantially tangential discharge flow is to be used. However, in such cases, it may be desirable to modify the taper 79 of the nozzle inlet 71 to maintain a smooth transition for fluid flow converging into the nozzle inlet channel 72 from the fluid passageway 62.

In operation, fluid may be centrifugally forced by rotation of the centrifuge rotor 10 into the nozzle 70 in a direction substantially parallel to the bore axis A1 via the fluid passageway 62. Upon reaching an end of the inlet channel 72 of the nozzle 70, the fluid impacts an inner surface of the insert 80, such as a surface of the directing portion 84, which causes the fluid flow to alter its course in a direction along the outlet axis A2. Due to the configuration of the insert 80 and/or the angular orientation of the nozzle 70 relative to the bore axis A1, this altered flow direction along the outlet axis A2 is substantially tangential to the outer diameter of the bowl 12. For example, this altered flow direction may be between approximately 80 degrees and approximately 110 degrees relative to a radius of the bowl 12. In one embodiment, the altered flow direction may be less than approximately 10 degrees off tangential to the outer diameter of the bowl 12. Moreover, the nozzles 70 may provide for a smooth streamlined fluid flow out through the orifice portion 82, such as is described in detail in U.S. Pat. No. 6,511,005, the contents of which are herein incorporated by reference in its entirety. Thus, the stream exiting the nozzles 70 may be only minimally dispersed or diffracted, and so may have a substantially cylindrical flow stream, as opposed to a conically spreading flow stream. For example, the nozzles 70 may have an almost “pencil like” discharge flow path.

The extended bowl inserts 16 allow the nozzles 70 to project beyond the outside diameter of the bowl 12, such that flow discharged therefrom may be substantially tangential to the outer diameter of the bowl 12 without impacting upon the bowl 12, and without the need for scallops in the bowl 12 adjacent the nozzles 70. In addition, by positioning the nozzles 70 on multiple planes P1, P2, as opposed to a single plane, the nozzles 70 may be spaced sufficiently far apart from each other so as to provide substantially tangential discharge flow streams without causing wear problems on each other. For example, the nozzles 70 on the first plane P1 may be spaced apart sufficiently to avoid discharge flow from any nozzle 70 on the first plane P1 impacting another nozzle 70 (or associated bowl insert 16) on the first plane P1, and the nozzles 70 on the second plane P2 may be spaced apart sufficiently to avoid discharge flow from any nozzle 70 on the second plane P2 impacting another nozzle 70 (or associated bowl insert 16) on the second plane P2. Moreover, utilizing nozzles 70 having a substantial “pencil like” flow discharge pattern allows the two planes P1, P2 of nozzles 70 to be relatively close to each other without having discharge flow from a nozzle 70 on the first plane P1 impact a nozzle 70 (or associated bowl insert 16) on the second plane P2. Thus, the cylindrical section 24 at the largest diameter of the bowl 12 may be kept to a minimum width.

In addition, by staggering the nozzle holes 14 on first and second planes P1, P2, a small amount of turbulence may be created in each zone entering the discharge nozzles 70 (e.g. within the bowl chamber 22 proximate the nozzle holes 14), which is where the heavy particles may be most concentrated. Thus, the staggered arrangement may provide the additional benefit of helping to separate any lighter particles caught up in the heavy particle streams to aid in separation.

Due to the high rotational velocity of the bowl 12 during operation, it may be desirable to design the backsides of the extended bowl inserts 16 in an aerodynamic manner to reduce the amount of noise and friction loss. For example, the backsides of the bowl inserts 16 may be rounded or tapered to provide an aerodynamic surface.

While the extended bowl insert 16 is shown and described as occupying the entire nozzle hole 14, the bowl insert 16 may be sized to only occupy a portion of the nozzle hole 14. For example, in one embodiment, the portion of the extended bowl insert 16 occupying the third bore 44 of the nozzle hole 14 may be eliminated. In such cases, the third bore 44 may be tapered to provide a smooth transition for fluid flow entering the extended bowl insert 16.

In an alternative embodiment, the extended bore insert 16 may be replaced with a similar bore insert which does not extend beyond the outer diameter of the bowl 12. In this case, the nozzle 70 may be configured to extend beyond the outer diameter of the bowl 12 on its own. For example, with the bore insert not extending beyond the outer diameter of the bowl 12, the locking groove 68 likewise may not extend beyond the outer diameter of the bowl, and so the lug 90 of the nozzle 70 may be positioned closer to the nozzle inlet 71 such that the nozzle 70 may project beyond the outside diameter of the bowl 12, in order to achieve the substantially tangential flow discharge therefrom. In addition or alternatively, the nozzle 70 may be lengthened in order to project beyond the outside diameter of the bowl 12.

In another alternative embodiment, the bowl insert 16 may be eliminated entirely along with the O-ring 54. In this case, the nozzle hole 14 may be sized to directly receive the nozzle 70, and may be tapered similarly to the fluid passageway 62 and include a cavity similar to the previously described cavity 64 for retaining the nozzle 70 and projecting the nozzle 70 beyond the outside diameter of the bowl 12. In other words, various features (e.g., the overall shape and configuration) of the bowl inserts 16 previously shown and described may be incorporated directly with the body of the bowl 12 at the nozzle holes 14. However, such a configuration exposes the bowl 12 to fluid flow within the nozzle holes 14, and thus may result in significant wear to the bowl 12, which may be very costly to repair. The bowl inserts 16, on the other hand, may protect the bowl 12 from such wear. Moreover, the bowl inserts 16 are relatively inexpensive and can be easily replaced in the event that they become significantly worn by fluid flow or otherwise damaged.

In the embodiments shown, the bowl 12, extended bowl insert 16, and nozzle 70 are shown as separate components of the centrifuge rotor 10. However, one or more of these components may be integrally formed as unitary piece(s) without departing from the scope of the invention.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A centrifuge rotor comprising:
a bowl including a bowl chamber for receiving a slurry to be separated and a first plurality of nozzle holes positioned on a first plane along a middle portion of the bowl and a second plurality of nozzle holes positioned on a second plane along the middle portion of the bowl, the middle portion including a largest outside diameter of the bowl, the first plane defining a centerline for the first plurality of nozzle holes and the second plane defining a centerline for the second plurality of nozzle holes, and wherein each nozzle hole is configured to receive a discharge nozzle so that each of the discharge nozzles protrude beyond the largest outside diameter of the bowl to direct fluid flow from the bowl chamber substantially tangentially to the largest outside diameter of the bowl.

2. The centrifuge rotor of claim 1, wherein the largest outside diameter of the bowl is a constant diameter.

3. The centrifuge rotor of claim 1, wherein the first plurality of nozzle holes are offset relative to the second plurality of nozzle holes.

4. The centrifuge rotor of claim 1, further comprising a plurality of discharge nozzles, with each of the plurality of discharge nozzles positioned within a corresponding nozzle hole of the first and second pluralities of nozzle holes and protruding beyond the largest outside diameter of the bowl to direct fluid flow from the bowl chamber substantially tangentially to the largest outside diameter of the bowl.

5. The centrifuge rotor of claim 4, further comprising a plurality of extended bowl inserts, with each of the plurality of extended bowl inserts positioned within a corresponding nozzle hole of the first and second pluralities of nozzle holes and wherein each of the discharge nozzles is positioned within a corresponding extended bowl insert.

6. The centrifuge rotor of claim 1, wherein each of the first plurality of nozzle holes and each of the second plurality of nozzle holes are equally spaced apart at regular intervals.

7. The centrifuge rotor of claim 1, wherein the first and second pluralities of nozzle holes each include approximately 15 nozzle holes.

8. The centrifuge rotor of claim 4, wherein each nozzle hole defines a bore axis, and wherein each discharge nozzle includes an insert having a directing portion for diverting fluid flow along an outlet axis substantially perpendicular to the corresponding bore axis.

9. The centrifuge rotor of claim 8, wherein each outlet axis is angled between approximately 80 degrees and approximately 110 degrees relative to the corresponding bore axis.

10. The centrifuge rotor of claim 9, wherein each discharge nozzle defines a nozzle inlet channel axis substantially aligned with the corresponding bore axis, and wherein a surface of the directing portion is angled between approximately 80 degrees and approximately 110 degrees relative to the nozzle inlet channel axis.

11. The centrifuge rotor of claim 9, wherein each discharge nozzle defines a nozzle inlet channel axis angled relative to the corresponding bore axis, and wherein a surface of the directing portion is angled greater than approximately 110 degrees relative to the nozzle inlet channel axis.

12. The centrifuge rotor of claim 4, wherein each discharge nozzle has a substantially cylindrical flow stream.

13. The centrifuge rotor of claim 4, wherein each discharge nozzle is configured to direct flow at an angle between approximately 80 degrees and approximately 110 degrees relative to the largest outside diameter of the bowl.

14. The centrifuge rotor of claim 13, wherein each discharge nozzle is configured to direct flow at an angle within approximately 10 degrees of tangential to the largest outside diameter of the bowl.

15. The centrifuge rotor of claim 1, wherein the first and second pluralities of nozzle holes are equally spaced from a centerline of the middle portion.

16. The centrifuge rotor of claim 1, further comprising a third plurality of nozzle holes positioned on a third plane along the middle portion of the bowl.

17. A disc nozzle centrifuge comprising the centrifuge rotor of claim 1.

18. A centrifuge rotor comprising:
a bowl including a bowl chamber for receiving a slurry to be separated and a first plurality of nozzle holes positioned on a first plane along a middle portion of the bowl and a second plurality of nozzle holes positioned on a second plane along the middle portion of the bowl, the middle portion including a largest outside diameter of the bowl, wherein the first plane defines a centerline for the first plurality of nozzle holes and the second plane defines a centerline for the second plurality of nozzle holes, the first plurality of nozzle holes are offset relative to the second plurality of nozzle holes, each of the first plurality of nozzle holes and each of the second plurality of nozzle holes are equally spaced apart at regular intervals, and the largest outside diameter of the bowl is a constant diameter; and
a plurality of discharge nozzles, with each of the plurality of discharge nozzles positioned within a corresponding nozzle hole of the first and second pluralities of nozzle holes and protruding beyond the largest outside diameter of the bowl to direct fluid flow from the bowl chamber substantially tangentially to the largest outside diameter of the bowl.

19. A method for centrifuging a slurry, the method comprising:
supplying a slurry including fluid to a bowl of a centrifuge rotor having a first plurality of discharge nozzles centered on a first plane along a middle portion of the bowl and a second plurality of discharge nozzles centered on a second plane along the middle portion of the bowl, the middle portion including a largest outside diameter of the bowl;
centrifugally forcing, via rotation of the bowl, at least a portion of the fluid into the first and second pluralities of discharge nozzles; and
directing the centrifugally forced fluid out of the first and second pluralities of discharge nozzles in a direction substantially tangential to the largest outside diameter of the bowl.

20. The method of centrifuging of claim 19, wherein directing the centrifugally forced fluid includes impacting the centrifugally forced fluid on a surface of an insert positioned within each of the first and second pluralities of discharge nozzles and out of the first and second pluralities of discharge nozzles in the direction substantially tangential to the largest outside diameter of the bowl.

21. The method of centrifuging of claim 19, wherein directing the centrifugally forced fluid includes directing the centrifugally forced fluid out of the first and second pluralities of discharge nozzles at an angle between approximately 80 degrees and approximately 110 degrees relative to the largest outside diameter of the bowl.

22. The method of centrifuging of claim 21, wherein directing the centrifugally forced fluid includes directing the centrifugally forced fluid out of the first and second pluralities of discharge nozzles at an angle within approximately 10 degrees of tangential to the largest outside diameter of the bowl.

23. The method of centrifuging of claim 19, wherein directing the centrifugally forced fluid includes directing the centrifugally forced fluid out of the first and second pluralities of discharge nozzles in the direction substantially tangential to the outside diameter of the bowl without impacting the bowl or the plurality of discharge nozzles with the fluid.

24. The method of centrifuging of claim 19 wherein the first plurality of discharge nozzles are offset relative to the second plurality of discharge nozzles.

25. The method of centrifuging of claim 19 wherein each of the first and second pluralities of discharge nozzles are situated within a corresponding nozzle hole included in the bowl.
